(19) United States
(12) Patent Application Publication
(10) Pub. No.: US 2025/0364713 A1
(43) Pub. Date: Nov. 27, 2025

(54) Dielectric Element in Component Carrier Embedded Waveguide

(71) Applicant: AT&S Austria Technologie & Systemtechnik Aktiengesellschaft, Leoben (AT)

(72) Inventors: Ahmad Bader ALOTHMAN ALTERKAWI, Graz (AT); Christian VOCKENBERGER, Leoben (AT)

(21) Appl. No.: 18/997,114

(22) PCT Filed: Jun. 27, 2023
(86) PCT No.: PCT/EP2023/067452

§ 371 Date: Jan. 20, 2025

(30) Foreign Application Priority Data
Jul. 20, 2022 (EP) 22186099.2

(51) Int. Cl. H01P 3/12; H01P 3/06; H01P 3/16; H01P 11/00

(52) U.S. Cl. CPC H01P 3/121; H01P 3/06; H01P 3/122; H01P 3/16; H01P 11/006

(57) ABSTRACT

A component carrier includes i) a stack with at least one electrically insulating layer structure and/or at least one electrically conductive layer structure; ii) a cavity, at least partially provided in the stack and delimited by a plurality of sidewalls, iii) a metallic shielding structure in the cavity that at least partially covers the plurality of sidewalls; and iv) a dielectric element of a material having a dielectric constant, Dk, of two or more arranged in the cavity.

### CROSS REFERENCE TO RELATED APPLICATIONS

This application is a national stage application, filed under 35 U.S.C. § 371, of International Patent Application No. PCT/EP2023/067452, filed on Jun. 27, 2023, claiming priority of patent application Ser. No. 22/186,099.2 filed on Jul. 20, 2022, in the European Patent Office, the disclosures of these patent applications being incorporated by reference herein in their entirety.

### TECHNICAL FIELD

The disclosure relates to a component carrier with a cavity, and a dielectric element arranged in said cavity. Further, the disclosure relates to a method of manufacturing the component carrier. Additionally, the disclosure relates to a use of a dielectric element in a component carrier cavity.

Thus, the disclosure may relate to the technical field of component carriers such as printed circuit boards and IC substrates, in particular in the context of signal transmission.

### Technological Background

In the context of growing product functionalities of component carriers equipped with one or more electronic components and increasing miniaturization of such electronic components as well as a rising number of electronic components to be mounted on the component carriers such as printed circuit boards, increasingly more powerful array-like components or packages having several electronic components are being employed, which have a plurality of contacts or connections, with ever smaller spacing between these contacts. Removal of heat generated by such electronic components and the component carrier itself during operation becomes an increasing issue. At the same time, component carriers shall be mechanically robust and electrically and magnetically reliable so as to be operable even under harsh conditions.

In particular, providing a component carrier with an efficient and reliable electromagnetic signal transmission in a compact (robust) but still design flexible manner remains a challenge. Tunnel structures with metallic sidewalls (waveguides) may be known to transmit electromagnetic waves. However, these structures are optimized for high frequencies, and, when the operation frequency is lowered, the size of the waveguides needs to increase. Hereby, miniaturization may be attractive for recent and upcoming high frequency applications.

### SUMMARY

There may be a need to provide a component carrier with an efficient and reliable electromagnetic signal transmission in a compact (robust), but still design flexible, manner.

A component carrier, a manufacture method, and a use are provided.

According to a first embodiment of the disclosure, there is described a component carrier, comprising: i) a (layer) stack comprising at least one electrically insulating layer structure and/or at least one electrically conductive layer structure; ii) a cavity, at least partially provided (embedded) in the stack and delimited by a plurality of sidewalls (in particular of stack material), iii) a metallic shielding structure (in particular a copper layer) in the cavity, wherein the metallic shielding structure at least partially (in particular fully) covers the plurality of sidewalls; and iv) a dielectric element (e.g. a ceramic material) arranged in the cavity, wherein the dielectric element comprises a material having a dielectric constant, Dk, of two or more.

According to a second embodiment of the disclosure, there is described a method of manufacturing a component carrier (e.g. as described above), wherein the method comprises: i) forming a stack comprising at least one electrically insulating layer structure and/or at least one electrically conductive layer structure; ii) forming a cavity at least partially in the stack, wherein the cavity is delimited by a plurality of sidewalls; iii) at least partially covering the sidewalls with a metallic shielding structure; and iv) arranging a dielectric element in the cavity, wherein the dielectric element comprises a material with a dielectric constant, Dk, of two or more.

According to a third embodiment of the disclosure, there is described a method of using a dieletric element with a dielectric constant, Dk, material of two or more in a waveguide, which waveguide is at least partially embedded in a component carrier (in particular to shift down frequencies, apply low frequencies without essentially) increasing the size).

### Overview of Embodiments

In the context of the present document, the term “cavity” may particularly denote any opening in a component carrier material and/or layer stack (in other words a volume without the component carrier/stack material). The component carrier/stack material may hereby delimit the cavity. In one example, the cavity may be fully embedded and delimited by component carrier material. In this example, the cavity may be arranged within the stack. In another example, the cavity may be only partially embedded in component carrier material, in other words only formed partially in the stack. For example, a part of the cavity may be formed outside the stack and this part may be delimited by additional metallic shielding structures.

The term “sidewall” may in this context denote any wall that delimits the cavity. While the cavity may comprise four sidewalls oriented parallel with the vertical (z) direction, the cavity may further comprise a top sidewall and a bottom sidewall, respectively oriented parallel to the horizontal (x, y) plane.

In the context of the present document, the term “metallic shielding structure” may particularly denote any structure configured to at least partially delimit the cavity (and/or cover the sidewall(s) that delimit the cavity) and which structure comprises a metal material. In one example, the metallic shielding structure may comprise only metal material. In another example, the main part of the metallic shielding structure may comprise metal, while non-metal substances may be present as well. The metallic shielding structure may be in particular configured to shield electromagnetic radiation/waves from leaving the cavity. Hereby, the metallic shielding structure may be configured to shield electromagnetic waves to remain in the cavity and move therein in a specific direction. Hence, the metallic shielding structure may cover the cavity sidewalls, so that a waveguide within the stack is provided. While in one example, the metallic shielding structure may be configured as a metal layer, preferably a continuous metal layer, in another example, the metallic shielding structure may comprise a plurality of (metal) vias, e.g. rectangular or circular pillars. In a specific example, the metallic shielding structure may be configured as a copper layer that covers electrically insulating stack material of the sidewalls. In an example, the metallic shielding structure may be applied by plating or PVD/CVD. In an embodiment, the thickness of the metallic shielding structure (layer) is in the range from 2 microns to 60 microns.

In the context of the present document, the term “waveguide” may particularly denote a structure configured to guide a wave, in particular an electromagnetic wave. The waveguide may represent a physical constraint for the waves to keep the intensity and to avoid a decrease by expanding into space. In a basic example, a waveguide may be configured as a hollow metallic channel. In a more advanced example, the waveguide may comprise a plurality (e.g. six) metallic sidewalls. Such a waveguide structure may be (at least partially) embedded in a component carrier layer stack, e.g. by providing a cavity and covering the sidewalls with the metallic shielding structure. According to a further definition, a waveguide may be an electromagnetic feed line that is used for high frequency signals. Waveguides may conduct microwave energy at lower loss than coaxial cables and are used e.g. in microwave communications, radars, and other high frequency applications. The waveguide may comprise a shape (in cross-section) that is e.g. rectangular, ridged, double ridged, kinked, L-shaped, Z-shaped, oval, or circular. The term “ridged form” is established and refers to a U-shaped cavity (seen in cross-section). The term “double ridged” is also established and refers to an H-shaped cavity (seen in cross-section).

In the context of the present document, the term “dielectric element” may particularly denote any element that may be configured to interact with a signal in the form of an electromagnetic wave and that comprises dielectric material. Even though the dielectric element as such may consist of dielectric material, a metal layer and/or coating may be formed at an outer surface of the dielectric element. In an embodiment, the dielectric element may further provide an electromagnetic functionality, for example an antenna, radar functionality, a filter functionality, an RF/HF coupling functionality. In one example, the dielectric material comprises a polymer and/or a ceramic, e.g. a polymer-ceramic composite. In another example, the dielectric element comprises a low temperature co-fired ceramic (LTCC). In a preferred embodiment, the dielectric material is a non-layer stack material, i.e. different in its physical/chemical properties from electrically insulating material of the component carrier layer stack. The dielectric element is not limited in its shape, and may for example be block-shaped, rectangular-shaped, circular-shaped, and/or structured. For example, the dielectric element may be configured as a dielectric antenna such as a dielectric resonator antenna. In another example, the dielectric element may be configured as a filter or an RF/HF coupling device. In one example, the dielectric element may be a completely dielectric element. In another example, the dielectric element may comprise a (thin) metal structure such as a coating (e.g. a thin copper coating) on at least one surface.

In the context of the present document, the term “component carrier” may particularly denote any support structure which is capable of accommodating one or more components thereon and/or therein for providing mechanical support and/or electrical connectivity. In other words, a component carrier may be configured as a mechanical and/or electronic carrier for components. In particular, a component carrier may be one of a printed circuit board, an organic interposer, and an IC (integrated circuit) substrate. A component carrier may also be a hybrid board combining different ones of the above-mentioned types of component carriers.

In an embodiment, the component carrier comprises a (layer) stack of at least one electrically insulating layer structure and at least one electrically conductive layer structure. For example, the component carrier may be a laminate of the mentioned electrically insulating layer structure(s) and electrically conductive layer structure(s), in particular formed by applying mechanical pressure and/or thermal energy. The mentioned stack may provide a plate-shaped component carrier capable of providing a large mounting surface for further components and being nevertheless very thin and compact. The term “layer structure” may particularly denote a continuous layer, a patterned layer or a plurality of non-consecutive islands within a common plane.

According to an exemplary embodiment, the disclosure may be based on the idea that a component carrier with an efficient and reliable electromagnetic signal transmission can be provided in a compact (robust), but still design flexible manner, when the sidewalls of a cavity in the component carrier stack are covered with a metallic shielding structure, and when a dielectric element (with a high dielectric constant material) is arranged in said cavity.

The cavity with the metallic sidewalls may be applied as a waveguide that is embedded in the stack of the component carrier. It has been surprisingly found by the inventors, that the placement of a dielectric element with a high dielectric constant material inside the waveguide may significantly improve the signal transmission quality. In particular, lower frequencies may be efficiently transmitted without a need to further increase the size of the waveguide. In other words, by embedding a high dielectric constant material within the stack-embedded waveguide, the operational resonance frequency may be lowered, e.g. for microwave, and mm-wave applications such as antenna, filter, coupler, or other (microwave) components/circuits.

Conventional waveguides are suitable for microwaves and higher frequencies (for example 300 MHz to 1 THz). For lower frequencies (e.g. 100 MHz to 5 GHz), a large increase in space requirements would have to be taken into account.

However, the surprisingly advantageous effect of the dielectric element enables applications with lower frequencies by using the same size and dimension (of the waveguide) as for high frequencies. In a specific example, a size reduction in the range 30 to 40% has been possible by the described architecture. Furthermore, the described component carrier with embedded waveguide may be manufactured with standard PCB manufacture process, so that implementation into existing production lines may be straightforward.

According to an embodiment, the metallic shielding structure extends in parallel to the layers of the stack. In this manner, the cavity may be configured as an elongated tunnel through the stack, whereby the tunnel walls are (at least partially) metal-covered. This may provide the advantage that an efficient and robust waveguide structure is embedded in the component carrier. Electromagnetic waves may be transported efficiently and reliably in a specific direction along the component carrier (horizontal direction). A metal layer that is parallel with layers of the stack may be especially robust. In an example, electrically conductive layer structures of the stack may at least partially serve as metallic shielding structures.

In another embodiment, the metallic shielding structure extends perpendicular to the layers of the stack, providing a waveguide in the vertical direction (along z).

According to a further embodiment, the material of the dielectric element comprises a dielectric constant (Dk) in the range from 2 to 100, in particular in the range from 2 to 80, more in particular from 2 to 20, more in particular in the range from 4 to 20 (or a dielectric constant of 4 (in particular 4.5) or larger). In other words, the dielectric element comprises a high permittivity, thereby allowing size reduction.

According to a further embodiment, the metallic shielding structure comprises metal layers and/or metal-filled vias. This may provide the advantage that established materials and their manufacturing technology, in the field of PCB manufacturing, may be directly applied. For example, there are several efficient methods of how a metal (copper) layer is formed on a component carrier material sidewall. Furthermore, (copper) vias, e.g. in the form of pillars, may be formed as a delimitation of the cavity. In an example, both options are combined, e.g. layers at the top and bottom of the cavity, and vias at the sides.

According to a further embodiment, the surface of the metallic shielding structure is at least partially covered by a surface finish (e.g. gold, palladium, etc., see further examples below). Thereby, oxidation may be prevented and/or signal transmission may be enhanced.

According to a further embodiment, the dielectric element is configured as a discontinuous dielectric layer structure, in particular as an array of dielectric sub-elements. In a first example, there may be exactly one dielectric element placed in the cavity. In a further example, two or more, in particular three or more, dielectric elements may be arranged in the cavity (see FIG. 5). In another example, a plurality of dielectric elements may be placed in the cavity, for example in the form of an array (see FIG. 6). In such a case, the dielectric elements may be seen as a discontinuous layer that comprises a plurality of dielectric elements, in particular in a common plane. Such a discontinuous layer may be manufactured from one original continuous layer that is then separated/patterned. Alternatively, the discontinuous layer may be seen as the dielectric element with dielectric element subsections. Dielectric elements and/or dielectric element subsections may be adjacent (side-by-side) to each other. Hereby, the dielectric elements may not be in physical contact, but there is no further component placed in between. Preferably, the dielectric elements may have the same extensions. Alternatively, the extensions of the dielectric elements may be different.

According to a further embodiment, the cavity and the metallic shielding structure form a waveguide. As already discussed above, the metallic shielding structure may delimit a tunnel within the component carrier through which electromagnetic waves may propagate in a specific direction. In this manner, an efficient and reliable waveguide may be provided that can be significantly improved through the dielectric element.

According to a further embodiment, the cavity is filled with at least one of a fluid, in particular air, a vacuum, an electrically insulating component carrier material. Different media may be applied to partially or completely fill the cavity between the metallic shielding structures. Depending on the desired application, the most suitable properties may be chosen. The electrically insulating component carrier material may be an encapsulation medium, e.g. a resin. In an example, said material is identical to a stack material. In another example, said material is a typical component carrier material (see listing below), but is a different material than that of the stack.

According to a further embodiment, the dielectric element is embedded in component carrier material (embedding/encapsulation material, mold material) in the cavity. In a specific example, the dielectric element is embedded in the center of the cavity with respect to the thickness direction (z) that is perpendicular to the extension of the layers of the stack. Additionally or alternatively, the dielectric element is embedded in the center of the cavity with respect to the length/width (x, y) direction that is parallel to the extension of the layers of the stack.

According to a further embodiment, the dielectric element is at least partially covered by a coating, in particular a metal coating (e.g. a copper layer). By taking this measure, specific properties of the dielectric element are advantageously provided in a selective manner.

According to a further embodiment, an operation frequency is in the range of 100 MHz to 5 GHz. The operation frequency may depend on the size of the waveguide, in particular the width. Due to the dielectric element, the size requirements may not be increased for lower frequencies.

According to a further embodiment, the dielectric element comprises at least one material of a polymer, a ceramic, a composite of a polymer and a ceramic, a polymer resin, a thermoplastic material, a curable material, a photoresist, a photo-polymer, a polymer with a filler material, a polymer with a ceramic powder filler material, a polymer with a fiber filler material.

According to a further exemplary embodiment, the dielectric element comprises a polymer and/or a ceramic. In particular, a composite of a polymer and a ceramic (for example a polymer matrix with a ceramic filler such as powder, particles, or fibers). This may provide the advantage that an industry relevant material can be directly provided in a cost-efficient manner.

According to a further exemplary embodiment, the polymer comprises at least one of: a polymer resin, a thermoplastic material, a curable material, a photoresist, a photopolymer, a polymer with a filler material (in particular a (ceramic) powder material or a fiber material). This may also provide the advantage that an industry relevant material can be directly provided in a cost-efficient manner.

In an embodiment, polymer resins (e.g. polyimide, polystyrene (sulfonate) (PSS)), photoresist polymers (e.g. polymethyl-methacrylate (PMMA), which is a positive photoresist and SU-8™ which is an epoxy-based negative photoresist) may be applied. In an example, to counterbalance a lower relative permittivity of pure polymer materials, a filler material with a high relative permittivity may be mixed or added to the polymer to create a composite material with enhanced dielectric properties. In particular, ceramic powders may be efficient filler materials, e.g. aluminum oxide, barium titanate oxide, zirconium oxide (further oxides of calcium, magnesium, titanium, bismuth, barium). The composite material may also include other fillers such as fiber materials, carbon nanotubes, CdS nanowires, and active ferroelectric materials.

In a specific example, the dielectric element comprises an ECCOS-TOCK HiK material with a dielectric constant of 10 and a loss tangent of 0.002.

According to a further exemplary embodiment, the dielectric element comprises at least one of the following features: a rectangular shape, a circular shape, at least one structured surface, a stack of several dielectric layers, at least one (cylindrical) hole in at least one surface, at least one protrusion, a central part with a plurality of protrusions. Depending on the desired circumstances, an advantageous shape can be implemented.

According to a further exemplary embodiment, there is described an electronic device, comprising: i) the component carrier as described above, and ii) at least one of the following functionalities: a 4G functionality, a 5G functionality, a 6G functionality, a microwave functionality, a mm-waveguide functionality, a WiFi functionality, an antenna functionality, a radar functionality, a filter functionality, an RF/HF coupling functionality.

The described component carrier may be integrated into the electronic device or may be arranged separately from the electronic device.

In the context of the present document, the term “antenna” may particularly denote an element connected for instance through a transmission line to a receiver or transmitter. Hence, an antenna may be denoted as an electrical member which converts electric power into radio waves, and/or vice versa. An antenna may be used with a controller (for instance a control chip) such as a radio transmitter and/or radio receiver. In transmission, a radio transmitter may supply an electric current oscillating at radio frequency (i.e. a high frequency alternating current) to the antenna, and the antenna may radiate the energy from the current as electromagnetic waves (in particular radio waves). In a reception mode, an antenna may intercept some of the power of an electromagnetic wave in order to provide a small voltage, that may be applied for example to a receiver to be amplified. In embodiments, the antenna may be configured as a receiver antenna, a transmitter antenna, or as a transceiver (i.e. transmitter and receiver) antenna. In an embodiment, the antenna structure may be used for a radar application. In one example, the antenna may be configured as a single antenna. In another example, the antenna may be configured as an (adhered, embedded) antenna array.

In the context of the present document, the terms “4G and/or 5G functionality” refer to known wireless system standards. The electronic device may also be suitable for future developments such as 6G. The electronic device may furthermore comply with WiFi standards such as 2.4 GHz, 5 GHZ, and 60 GHz. An electronic device may for example comprise a so-called wireless combo (integrated with WiFi, Bluetooth, GPS . . . ), a radio-frequency front end (RFFE), or a low-power wide area (LPWA) network module. The electronic device may for example be a laptop, a notebook, a smartphone, a portable WiFi dongle, a smart home appliance, or a machine-to-machine network module.

Furthermore, the electronic device may be used for a radar application, e.g. in an industrial field (industry radar) or in the automotive field. Hereby, the antenna structure and/or the dielectric element may be configured for a radar application. In the context of the present document, the term “radar” may refer to an object-detection that uses electromagnetic waves to determine the range, angle, or velocity of one or more objects. A radar arrangement may comprise a transmitter transmitting electromagnetic waves (e.g. in the radio or microwave range). The electromagnetic waves from the transmitter reflect off the object and return to a receiver. Hereby, one antenna structure may be used for transmitting and receiving. Furthermore, a processor such as an electronic component may be used to determine properties of the object such as location and speed based on the received electromagnetic waves.

According to a further embodiment, the length of the waveguide (x) is larger than the width (y), which is larger than the height (z).

In an embodiment, the stack comprises at least one electrically insulating layer structure and at least one electrically conductive layer structure. For example, the component carrier may be a laminate of the mentioned electrically insulating layer structure(s) and electrically conductive layer structure(s), in particular formed by applying mechanical pressure and/or thermal energy. The mentioned stack may provide a plate-shaped component carrier capable of providing a large mounting surface for further components and being nevertheless very thin and compact.

In an embodiment, the component carrier is shaped as a plate. This contributes to the compact design, wherein the component carrier nevertheless provides a large basis for mounting components thereon. Furthermore, in particular a naked die as an example of an embedded electronic component, can be conveniently embedded, thanks to its small thickness, into a thin plate such as a printed circuit board.

In an embodiment, the component carrier is configured as one of the group consisting of a printed circuit board, a substrate (in particular an IC substrate), and an interposer.

In the context of the present application, the term “printed circuit board” (PCB) may particularly denote a plate-shaped component carrier which is formed by laminating several electrically conductive layer structures with several electrically insulating layer structures, for instance by applying pressure and/or by the supply of thermal energy. As preferred materials for PCB technology, the electrically conductive layer structures are made of copper, whereas the electrically insulating layer structures may comprise resin and/or glass fibers, so-called prepreg or FR4 material. The various electrically conductive layer structures may be connected to one another in a desired way by forming holes through the laminate, for instance by laser drilling or mechanical drilling, and by partially or fully filling them with electrically conductive material (in particular copper), thereby forming vias or any other through-hole connections. The filled hole either connects the whole stack, (through-hole connections extending through several layers or the entire stack), or the filled hole connects at least two electrically conductive layers, called via. Similarly, optical interconnections can be formed through individual layers of the stack in order to receive an electro-optical circuit board (EOCB). Apart from one or more components which may be embedded in a printed circuit board, a printed circuit board is usually configured for accommodating one or more components on one or both opposing surfaces of the plate-shaped printed circuit board. They may be connected to the respective main surface by soldering. A dielectric part of a PCB may be composed of resin with reinforcing fibers (such as glass fibers).

In the context of the present application, the term “substrate” may particularly denote a small component carrier. A substrate may be a, in relation to a PCB, comparably small component carrier onto which one or more components may be mounted and that may act as a connection medium between one or more chip(s) and a further PCB. For instance, a substrate may have substantially the same size as a component (in particular an electronic component) to be mounted thereon (for instance in case of a Chip Scale Package (CSP)). In another embodiment, the substrate may be substantially larger than the assigned component (for instance in a flip chip ball grid array, FCBGA, configuration). More specifically, a substrate can be understood as a carrier for electrical connections or electrical networks as well as component carrier comparable to a printed circuit board (PCB), however with a considerably higher density of laterally and/or vertically arranged connections. Lateral connections are for example conductive paths, whereas vertical connections may be for example drill holes. These lateral and/or vertical connections are arranged within the substrate and can be used to provide electrical, thermal and/or mechanical connections of housed components or unhoused components (such as bare dies), particularly of IC chips, with a printed circuit board or intermediate printed circuit board. Thus, the term “substrate” also includes “IC substrates”. A dielectric part of a substrate may be composed of resin with reinforcing particles (such as reinforcing spheres, in particular glass spheres).

The substrate or interposer may comprise or consist of at least a layer of glass, silicon (Si) and/or a photoimageable or dry-etchable organic material like epoxy-based build-up material (such as epoxy-based build-up film) or polymer compounds (which may or may not include photo- and/or thermosensitive molecules) like polyimide or polybenzoxazole.

In an embodiment, the at least one electrically insulating layer structure comprises at least one of the group consisting of a resin or a polymer, such as epoxy resin, cyanate ester resin, benzocyclobutene resin, bismaleimide-triazine resin, polyphenylene derivate (e.g. based on polyphenylenether, PPE), polyimide (PI), polyamide (PA), liquid crystal polymer (LCP), polytetrafluoroethylene (PTFE) and/or a combination thereof. Reinforcing structures such as webs, fibers, spheres or other kinds of filler particles, for example made of glass (multilayer glass) in order to form a composite, could be used as well. A semi-cured resin in combination with a reinforcing agent, e.g. fibers impregnated with the above-mentioned resins is called prepreg. These prepregs are often named after their properties e.g. FR4 or FR5, which describe their flame-retardant properties. Although prepreg particularly FR4 are usually preferred for rigid PCBs, other materials, in particular epoxy-based build-up materials (such as build-up films) or photoimageable dielectric materials, may be used as well. For high frequency applications, high-frequency materials such as polytetrafluoroethylene, liquid crystal polymer and/or cyanate ester resins, may be preferred. Besides these polymers, low temperature cofired ceramics (LTCC) or other low, very low or ultra-low DK materials may be applied in the component carrier as electrically insulating structures.

In an embodiment, the at least one electrically conductive layer structure comprises at least one of the group consisting of copper, aluminum, nickel, silver, gold, palladium, tungsten, magnesium, carbon, (in particular doped) silicon, titanium, and platinum. Although copper is usually preferred, other materials or coated versions thereof are possible as well, in particular materials coated with supra-conductive material or conductive polymers, such as graphene or poly(3,4-ethylenedioxythiophene) (PEDOT), respectively.

At least one further component may be embedded in and/or surface mounted on the stack. The component and/or the at least one further component can be selected from a group consisting of an electrically non-conductive inlay, an electrically conductive inlay (such as a metal inlay, preferably comprising copper or aluminum), a heat transfer unit (for example a heat pipe), a light guiding element (for example an optical waveguide or a light conductor connection), an electronic component, or combinations thereof. An inlay can be for instance a metal block, with or without an insulating material coating (IMS-inlay), which could be either embedded or surface mounted for the purpose of facilitating heat dissipation. Suitable materials are defined according to their thermal conductivity, which should be at least 2 W/mK. Such materials are often based, but not limited to metals, metal-oxides and/or ceramics as for instance copper, aluminum oxide (Al₂O₃) or aluminum nitride (AlN). In order to increase the heat exchange capacity, other geometries with increased surface area are frequently used as well. Furthermore, a component can be an active electronic component (having at least one p-n-junction implemented), a passive electronic component such as a resistor, an inductance, or capacitor, an electronic chip, a storage device (for instance a DRAM or another data memory), a filter, an integrated circuit (such as field-programmable gate array (FPGA), programmable array logic (PAL), generic array logic (GAL) and complex programmable logic devices (CPLDs)), a signal processing component, a power management component (such as a field-effect transistor (FET), metal-oxide-semiconductor field-effect transistor (MOSFET), complementary metal-oxide-semiconductor (CMOS), junction field-effect transistor (JFET), or insulated-gate field-effect transistor (IGFET), all based on semiconductor materials such as silicon carbide (SIC), gallium arsenide (GaAs), gallium nitride (GaN), gallium oxide (Ga₂O₃), indium gallium arsenide (InGaAs), indium phosphide (InP) and/or any other suitable inorganic compound), an optoelectronic interface element, a light emitting diode, a photocoupler, a voltage converter (for example a DC/DC converter or an AC/DC converter), a cryptographic component, a transmitter and/or receiver, an electromechanical transducer, a sensor, an actuator, a microelectromechanical system (MEMS), a microprocessor, a capacitor, a resistor, an inductance, a battery, a switch, a camera, an antenna, a logic chip, and an energy harvesting unit. However, other components may be embedded in the component carrier. For example, a magnetic element can be used as a component. Such a magnetic element may be a permanent magnetic element (such as a ferromagnetic element, an antiferromagnetic element, a multiferroic element or a ferrimagnetic element, for instance a ferrite core) or may be a paramagnetic element. However, the component may also be an IC substrate, an interposer or a further component carrier, for example in a board-in-board configuration. The component may be surface mounted on the component carrier and/or may be embedded in an interior thereof. Moreover, other components, in particular those which generate and emit electromagnetic radiation and/or are sensitive with regard to electromagnetic radiation propagating from an environment, may be used as a component.

In an embodiment, the component carrier is a laminate-type component carrier. In such an embodiment, the component carrier is a compound of multiple layer structures which are stacked and connected together by applying a pressing force and/or heat.

After processing interior layer structures of the component carrier, it is possible to cover (in particular by lamination) one or both opposing main surfaces of the processed layer structures symmetrically or asymmetrically with one or more further electrically insulating layer structures and/or electrically conductive layer structures. In other words, a build-up may be continued until a desired number of layers is obtained.

After having completed formation of a stack of electrically insulating layer structures and electrically conductive layer structures, it is possible to proceed with a surface treatment of the obtained layers structures or component carrier.

In particular, an electrically insulating solder resist may be applied to one or both opposing main surfaces of the layer stack or component carrier in terms of surface treatment. For instance, it is possible to form such a solder resist on an entire main surface and to subsequently pattern the layer of solder resist so as to expose one or more electrically conductive surface portions which shall be used for electrically coupling the component carrier to an electronic periphery. The surface portions of the component carrier remaining covered with solder resist may be efficiently protected against oxidation or corrosion, in particular surface portions containing copper.

It is also possible to apply a surface finish selectively to exposed electrically conductive surface portions of the component carrier in terms of surface treatment. Such a surface finish may be an electrically conductive cover material on exposed electrically conductive layer structures (such as pads, conductive tracks, etc., in particular comprising or consisting of copper) on a surface of a component carrier. If such exposed electrically conductive layer structures are left unprotected, then the exposed electrically conductive component carrier material (in particular copper) might oxidize, making the component carrier less reliable. A surface finish may then be formed for instance as an interface between a surface mounted component and the component carrier. The surface finish has the function to protect the exposed electrically conductive layer structures (in particular copper circuitry) and enable a joining process with one or more components, for instance by soldering. Examples for appropriate materials for a surface finish are Organic Solderability Preservative (OSP), Electroless Nickel Immersion Gold (ENIG), Electroless Nickel Immersion Palladium Immersion Gold (ENIPIG), Electroless Nickel Electroless Palladium Immersion Gold (ENEPIG), gold (in particular hard gold), chemical tin (chemical and electroplated), nickel-gold, nickel-palladium, etc. Also nickel-free materials for a surface finish may be used, in particular for high-speed applications. Examples are ISIG (Immersion Silver Immersion Gold), and EPAG (Electroless Palladium Autocatalytic Gold).

### BRIEF DESCRIPTION OF THE DRAWINGS

The aspects defined above, and further aspects of the disclosure are apparent from the examples of embodiment to be described hereinafter and are explained with reference to these examples of embodiment.

FIG. 1, FIG. 2, FIG. 3, and FIG. 4 respectively illustrate a side view of a component carrier according to exemplary embodiments of the disclosure.

FIG. 5, FIG. 6, and FIG. 7 respectively illustrate a top view of a component carrier according to exemplary embodiments of the disclosure.

### DETAILED DESCRIPTION OF ILLUSTRATED EMBODIMENTS

The illustrations in the drawings are schematically presented. In different drawings, similar or identical elements are provided with the same reference signs.

Before referring to the drawings, exemplary embodiments will be described in further detail, some basic considerations will be summarized based on which exemplary embodiments of the disclosure have been developed.

According to an exemplary embodiment, a dielectric element (e.g. a dielectric resonator), comprising one of the shapes listed above, is included in an embedded waveguide cavities with metallic walls within a PCB, using PCB manufacturing technologies. The shape of the dielectric resonator can depend on the application and can be fixed using an attach film. The dielectric resonator can be excited within the metallic cavities/waveguide structure in order to have a high-Q component at low frequencies compared to empty cavities/waveguide structures.

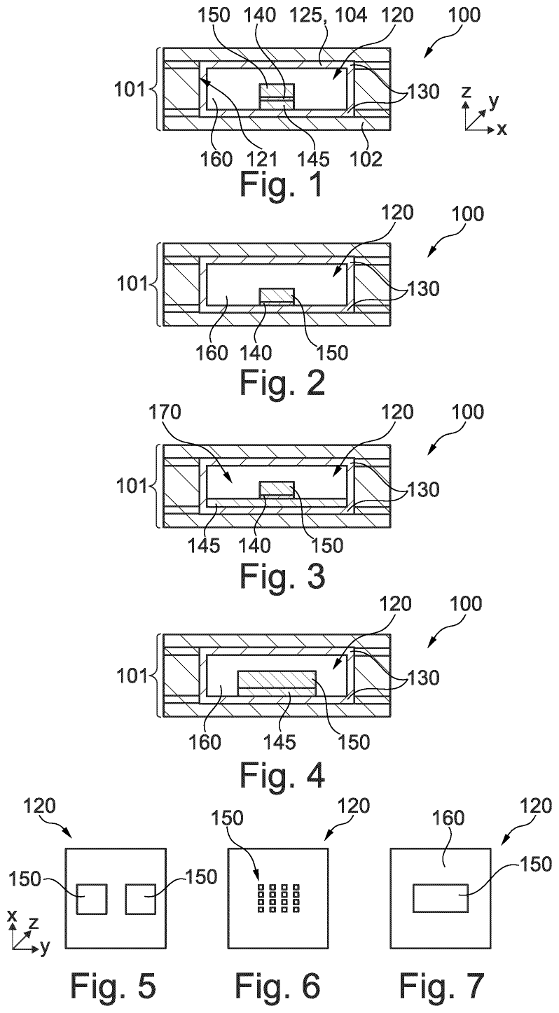

FIG. 1 illustrates a side view of a component carrier 100 according to an exemplary embodiment of the disclosure. The component carrier 100 comprises a stack 101 with a plurality of electrically insulating layer structures 102 and electrically conductive layer structures 104. In the center of the stack 101, there is embedded in the stack material a cavity 120. The cavity 120 is in the first place a void space delimited by a plurality (here six) of sidewalls 121 (the top wall and the bottom wall are also considered as sidewalls here) that consist of stack material (in the horizontal and vertical direction, there are arranged electrically insulating layer structures 102 of the stack 101). The plurality of sidewalls 121 are fully covered by a metallic shielding structure 125, in this example provided as a copper layer. Hereby, the metallic shielding structure can also be seen as an electrically conductive layer structure 104 of the stack 101.

The component carrier 100 further comprises a dielectric element (e.g. a ceramic material) 150 arranged in the cavity 120. The dielectric element comprises a material having a dielectric constant (Dk) of two or more, in particular between 4 and 20. At the bottom of the cavity 120, there is arranged a support structure 145 made of component carrier material (stack material, in particular resin, e.g. prepreg). An attach material 140 (e.g. an adhesive film, a glue, etc.) is formed on the support structure to adhere to the dielectric element 150 and to hold it securely in place at the center of the cavity 120. In this example, the dielectric element 150, the support structure 145 and the attach material 140 have the same horizontal extension. Furthermore, the dielectric element 150 is located on top of the attach material 140 without a horizontal misalignment and the attach material 140 is located on top of the support structure 145 without a horizontal misalignment. Moreover, the height of the dielectric element 150 is different to the height of the attach material 140 and the support structure 145. Furthermore, the height of the attach material 140 is different to the height of the support material 145.

In this example, the cavity 120 is filled with an electrically insulating embedding (encapsulation) material 160. It is further indicated with reference sign 130, that the cavity 120 and the metallic shielding structure 125 form a waveguide 130, whereby the dielectric element 150 is placed in the cavity 120.

FIG. 2 illustrates a side view of a component carrier 100 according to a further exemplary embodiment of the disclosure. This example is very similar to the one described for FIG. 1. Yet, the support structure 145 has been omitted and the dielectric element 150 is directly attached by the attach material 140 at the bottom of the cavity 120. The dielectric element 150 is thus not arranged in the cavity center with respect to the height (z) direction. Nevertheless, in this example, the dielectric element 150 is arranged in the middle with respect to the horizontal (x, y) direction.

FIG. 3 illustrates a side view of a component carrier 100 according to a further exemplary embodiment of the disclosure. This example is very similar to the one described for FIG. 1. Yet, in this example, the cavity 120 is not filled with the embedding material 160, but is instead filled with a fluid 170, for example air. Furthermore, the support structure 145 of component carrier material does not comprise the same extension in the horizontal direction as the dielectric element 150 (see FIG. 1), but covers instead the whole bottom of the cavity 120.

FIG. 4 illustrates a side view of a component carrier 100 according to a further exemplary embodiment of the disclosure. This example is very similar to the one described for FIG. 1. Yet, the attach structure 140 has been omitted, and the dielectric element 150 is directly arranged on the component carrier material 145, e.g. a prepreg (that also may comprise adhesive properties). In this example, the component carrier material 145 and the dielectric element 150 are extended in the horizontal direction in comparison to the examples of FIGS. 1 to 3.

FIG. 5 illustrates a top view on a cavity 120 of a component carrier 100 according to an exemplary embodiment of the disclosure. It can be seen that two dielectric elements 150 are arranged side-by-side (adjacent) to each other in the cavity 120. The dielectric element 150 are close to each other (no other component in between), but are not in physical contact with each other.

FIG. 6 illustrates a further top view on a cavity 120 of a component carrier 100 according to an exemplary embodiment of the disclosure. In comparison to the example of FIG. 5, a plurality of dielectric elements 150 are arranged in the cavity 120 and are placed in form of an array.

FIG. 7 illustrates a side view of a cavity 120 of a component carrier 100 according to an exemplary embodiment of the disclosure. In this example, the dielectric element 150 is arranged directly in the center of the cavity 120, in the vertical, as well as in the horizontal direction. This is enabled because the dielectric element 150 is completely embedded in, and held in place by, the embedding material 160.

### REFERENCE NUMERALS

100 Component carrier
101 Stack
102 Electrically insulating layer structure
104 Electrically conductive layer structure
120 Cavity
121 Sidewalls
125 Metallic shielding structure
130 Waveguide
140 Attach material
145 Support structure
150 Dieletric element
160 Embedding material
170 Fluid, air

1. A component carrier (100), comprising:
a stack comprising at least one electrically insulating layer structure and/or at least one electrically conductive layer structure;
a cavity, at least partially provided in the stack and delimited by a plurality of sidewalls,
a metallic shielding structure in the cavity, wherein the metallic shielding structure at least partially covers the plurality of sidewalls; and
a dielectric element arranged in the cavity,
wherein the dielectric element comprises a material having a dielectric constant (Dk), of two or more.

2. The component carrier according to claim 1,
wherein the metallic shielding structure extends in parallel to the layers of the stack.

3. The component carrier according to claim 1,
wherein the material of the dielectric element comprises a dielectric constant; (Dk), in a range from 2 to 80.

4. The component carrier according to claim 1,
wherein the metallic shielding structure comprises metal layers and/or metal-filled vias.

5. The component carrier according to claim 1,
wherein the dielectric element is configured as a discontinuous dielectric layer structure, in particular as an array of dielectric sub-elements.

6. The component carrier according to claim 1,
wherein the cavity and the metallic shielding structure form a waveguide.

7. The component carrier according to claim 1,
wherein the cavity is filled with at least one of a fluid, in particular air, vacuum, an electrically insulating component carrier material.

8. The component carrier according to claim 1,
wherein the dielectric element is embedded in component carrier material in the cavity, in particular in the center of the cavity with respect to the thickness direction that is perpendicular to the extension of the layers of the stack.

9. The component carrier according to claim 1,
wherein the dielectric element is at least partially covered by a coating, in particular a metal coating.

10. The component carrier according to claim 1,
wherein an operation frequency is in the range of 0.3 GHz to 300 GHz, in particular a frequency of 10 GHz or larger, more in particular 20 GHz or larger.

11. The component carrier according to claim 1,
wherein the dielectric element comprises at least one material of a polymer, a ceramic, a composite of a polymer and a ceramic, a polymer resin, a thermoplastic material, a curable material, a photoresist, a photo-polymer, a polymer with a filler material, a polymer with a ceramic powder filler material, a polymer with a fiber filler material.

12. The component carrier according to claim 1,
wherein the dielectric element comprises at least one of the following features: a rectangular shape, a circular shape, at least one structured surface, a stack of several dielectric layers, at least one cylindrical, hole in at least one surface, at least one protrusion, a central part with a plurality of protrusions.

13. An electronic device, comprising:
the component carrier according to claim 1, and
at least one functionality of: a 4G functionality, a 5G functionality, a mm-waveguide functionality, a WiFi functionality, an antenna functionality, a radar functionality, a filter functionality, an RF/HF coupling functionality.

14. A method of manufacturing a component carrier, the method comprising:
forming a stack comprising at least one electrically insulating layer structure and/or at least one electrically conductive layer structure;
forming a cavity, at least partially provided in the stack, wherein the cavity is delimited by a plurality of sidewalls;
at least partially covering the sidewalls with a metallic shielding structure; and
arranging a dielectric element in the cavity, wherein the dielectric element comprises a material with a dielectric constant (Dk), of two or more.

15. A method, comprising:
Using introducing a dieletric element of a material with a dielectric constant (Dk), of two or more in a waveguide structure,
at least partially embedding the dielectric element in a component carrier.

16. The component carrier according to claim 1,
wherein the dielectric element is attached to a bottom of the cavity by an attach material.
